(19) United States
(12) Patent Application Publication
(10) Pub. No.: US 2026/0046164 A1
(43) Pub. Date: Feb. 12, 2026

(54) METHODS AND SYSTEMS FOR WIRELESS COMMISSIONING AND MAINTENANCE OF VARIABLE AIR VOLUME (VAV) CONTROLLERS USING A PORTABLE HANDHELD DEVICE

(71) Applicant: Honeywell International Inc., Charlotte, NC (US)

(72) Inventors: Kevin M. Callahan, Seattle, WA (US); Nagasree Poluri, Bangalore (IN); Paul Clifton, Surrey (GB); Raghuraman Swaminathan, Tamil Nadu (IN); Rajat Saha, Bangalore (IN)

(21) Appl. No.: 19/290,847

(22) Filed: Aug. 5, 2025

(30) Foreign Application Priority Data
Aug. 7, 2024 (IN) 202411059577

(51) Int. Cl. H04L 12/28; H04L 12/66

(52) U.S. Cl. CPC H04L 12/2827; H04L 12/282; H04L 12/66; H04L 2012/2841

(57) ABSTRACT

A method and system for using a portable handheld device to commission and maintain Variable Air Volume (VAV) controllers in building management systems. The portable device establishes wireless connection with a gateway to access a building control network containing multiple VAV controllers coupled to a Building Management System (BMS) controller. The device receives information identifying application types for each VAV controller and adapts its display to show relevant VAV parameters for each controller type. Users can select controllers, modify parameters, and initiate test and balance procedures through the device's interface. During testing, VAV controllers can override BMS commands and automatically resume normal operation upon disconnection. The system supports various application types including single duct, dual duct, cooling configurations, and fan control options, enabling efficient commissioning and maintenance of building HVAC systems through a unified portable interface.

### RELATED APPLICATIONS

This application claims the benefit of Indian Provisional Application No. 202411059577, filed Aug. 7, 2024, which application is incorporated by reference herein.

### TECHNICAL FIELD

The present disclosure relates generally to relates to heating, ventilating, and air conditioning (HVAC) systems including variable air volume controllers and more particularly to wirelessly commissioning and maintaining variable air volume controllers using a portable handheld device.

### BACKGROUND

Variable Air Volume (VAV) systems are important components of modern building HVAC systems that regulate airflow to maintain optimal temperature and air quality in different zones of a building. These systems typically include multiple VAV controllers, each associated with a corresponding VAV box, that work together under the supervision of a Building Management System (BMS) controller through a building control network.

Traditional commissioning and maintenance of VAV systems has presented challenges for technicians who need to configure, test, and balance multiple controllers with varying application types and parameters. Each VAV controller may have different application types such as single duct, dual duct, cooling only, cooling with reheat, fan parallel, fan series, reheat, and heating configurations, each requiring specific VAV parameters for proper operation.

The commissioning process typically involves test and balance procedures to ensure proper airflow calibration, damper positioning, and system performance. However, conventional methods often require technicians to work directly with individual controllers or use complex interfaces that may not be optimized for field work. Additionally, during testing procedures, there can be a need to temporarily override BMS controller commands while ensuring the system can safely return to normal operation. What would be desirable are systems and methods for improved commissioning of VAV controllers. What would be desirable are systems and methods for wirelessly commissioning and maintaining VAV controllers via an intuitive user interface.

### SUMMARY

The present disclosure relates generally to relates to heating, ventilating, and air conditioning (HVAC) systems including variable air volume controllers and more particularly to wirelessly commissioning and maintaining variable air volume controllers using a portable handheld device. An example may be found in a method of using a portable handheld device to commission and/or maintain one or more of a plurality of Variable Air Volume (VAV) controllers that are each associated with a corresponding VAV box. The plurality of VAV controllers are operably connected together and operatively coupled to a Building Management System (BMS) controller via a building control network. The portable handheld device includes a user interface with display. The method includes the portable handheld device establishing a wireless connection with a gateway that provides access to the building control network. The portable handheld device receives via the gateway information about each of one or more of the plurality of VAV controllers that are operably connected to the building control network including information that identifies an application type from a plurality of application types for each of the one or more of the plurality of VAV controllers. Each application type has associated VAV parameters that are used in controlling the respective VAV controller. Based on the application type received for each of the one or more of the plurality of VAV controllers, the portable handheld device adapts the display for each of the one or more of the plurality of VAV controllers to display the VAV parameters that are associated with the application type of the respective VAV controller. The method includes receiving a selection of one of the one or more of the VAV controllers via the user interface of the portable handheld device and receiving a change to one or more of the VAV parameters that are associated with the application type of the selected VAV controller via the user interface of the portable handheld device, resulting in one or more changed VAV parameters. The portable handheld device sends the one or more changed VAV parameters to the selected VAV controller via the gateway. The selected VAV controller stores the one or more changed VAV parameters in a memory of the selected VAV controller and the selected VAV controller controls the selected VAV controller using the one or more changed VAV parameters.

Another example may be found in a method of using a portable handheld device to commission and/or maintain one or more of a plurality of Variable Air Volume (VAV) controllers that are each associated with a corresponding VAV box. The plurality of VAV controllers are operably connected together and are operatively coupled to a Building Management System (BMS) controller via a building control network. The portable handheld device includes a user interface with display. The method includes the portable handheld device establishing a wireless connection with a gateway that provides access to the building control network. The portable handheld device receives via the gateway information about each of one or more of the plurality of VAV controllers that are operably connected to the building control network, including information that identifies an application type of a plurality of application types for each of the one or more of the plurality of VAV controllers. Each application type has associated VAV parameters that are used in controlling the respective VAV controller. The plurality of application types includes two or more of single duct, dual duct, cooling only, cooling with reheat, fan parallel, fan series, reheat, and heating. Based on the application type received for each of the one or more of the plurality of VAV controllers, the portable handheld device adapts the display for each of the one or more of the plurality of VAV controllers to display the VAV parameters that are associated with the application type of the respective VAV controller.

Another example may be found in a system. The system includes a building control network, a Building Management System (BMS) controller, and a plurality of Variable Air Volume (VAV) controllers that are each associated with a corresponding VAV box. The plurality of VAV controllers are operably connected together and are operatively coupled to the BMS controller via the building control network. A wireless gateway provides access to the building control network. A portable handheld device includes a user interface with display. The portable handheld device is configured to establish a wireless connection with the wireless gateway. The portable handheld device is configured to receive via the wireless gateway information about each of one or more of the plurality of VAV controllers, including information that identifies an application type from a plurality of application types for each of the one or more of the plurality of VAV controllers. Each application type has associated VAV parameters that are used in controlling the respective VAV controller. The portable handheld device is configured to adapt the display for each of the one or more of the plurality of VAV controllers to display the VAV parameters that are associated with the application type of the respective VAV controller. The portable handheld device is configured to receive a selection of one of the one or more of the VAV controllers via the user interface. The portable handheld device is configured to receive a change to one or more of the VAV parameters that are associated with the application type of the selected VAV controller via the user interface, resulting in one or more changed VAV parameters. The portable handheld device is configured to send the one or more changed VAV parameters to the selected VAV controller via the wireless gateway. The portable handheld device is configured to initiate a test and balance procedure on the selected VAV controller via the user interface.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative building system;

FIGS. 2A, 2B, and 2C are flow diagrams that together show an illustrative method for using a portable handheld device to commission and/or maintain one or more VAV controllers;

FIGS. 3A and 3B are flow diagrams that together show an illustrative method for using a portable handheld device to commission and/or maintain one or more VAV controllers;

FIGS. 4A, 4B, 4C, and 4D are screenshots from a portable handheld device, demonstrating single duct calibration;

FIGS. 5A, 5B, 5C, and 5D are screenshots from a portable handheld device, demonstrating single point balancing;

FIGS. 6A, 6B, 6C are screenshots from a portable handheld device, demonstrating zero calibration;

FIGS. 7A, 7B, 7C, and 7D are screenshots from a portable handheld device, demonstrating editing move properties;

FIGS. 8A and 8B are screenshots from a portable handheld device, demonstrating fan type applications;

FIGS. 9A and 9B are screenshots from a portable handheld device, demonstrating independent balancing options;

FIGS. 10A and 10B are screenshots from a portable handheld device, demonstrating discovering multiple controllers; and

FIGS. 11A, 11B, 11C, and 11D are screenshots from a portable handheld device, demonstrating balancing multiple controllers.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

A system may include a building control network, a Building Management System (BMS) controller and a plurality of Variable Air Volume (VAV) controllers that are each associated with a corresponding VAV box, wherein the plurality of VAV controllers are operably connected together and operatively coupled to the BMS controller via the building control network. A wireless gateway provides access to the building control network. A portable handheld device includes a user interface with display. The portable handheld device is configured to establish a wireless connection with the wireless gateway and to receive via the wireless gateway information about each of one or more of the plurality of VAV controllers, wherein the information identifies an application type from a plurality of application types for each of the one or more of the plurality of VAV controllers, wherein each application type has associated VAV parameters that are used in controlling the respective VAV controller. The portable handheld device is configured to adapt the display for each of the one or more of the plurality of VAV controllers to display the VAV parameters that are associated with the application type of the respective VAV controller. The portable handheld device is configured to receive a selection of one of the one or more of the VAV controllers via the user interface. The portable handheld device is configured to receive a change to one or more of the VAV parameters that are associated with the application type of the selected VAV controller via the user interface, resulting in one or more changed VAV parameters. The portable handheld device is configured to send the one or more changed VAV parameters to the selected VAV controller via the wireless gateway and to initiate a test and balance procedure on the selected VAV controller via the user interface.

In some cases, a portable handheld device may be used to commission and/or maintain one or more of a plurality of Variable Air Volume (VAV) controllers that are each associated with a corresponding VAV box. The plurality of VAV controllers are operably connected together and are operatively coupled to a Building Management System (BMS) controller via a building control network. The portable handheld device includes a user interface with display. The portable handheld device establishes a wireless connection with a gateway that provides access to the building control network. The portable handheld device receives via the gateway information about each of one or more of the plurality of VAV controllers that are operably connected to the building control network, wherein the information identifies an application type from a plurality of application types for each of the one or more of the plurality of VAV controllers, wherein each application type has associated VAV parameters that are used in controlling the respective VAV controller. As an example, the plurality of application types may include two or more of single duct, dual duct, cooling only, cooling with reheat, fan parallel, fan series, reheat, and heating. For application types of fan parallel and/or fan series, the portable handheld device may display on option on the display to command a fan of the selected VAV controller to be ON or OFF and/or to adjust a fan speed of the fan.

Based on the application type received for each of the one or more of the plurality of VAV controllers, the portable handheld device adapts the display for each of the one or more of the plurality of VAV controllers to display the VAV parameters that are associated with the application type of the respective VAV controller. A selection of one of the one or more of the VAV controllers is received via the user interface of the portable handheld device. A change to one or more of the VAV parameters that are associated with the application type of the selected VAV controller is received via the user interface of the portable handheld device, resulting in one or more changed VAV parameters. The portable handheld device sends the one or more changed VAV parameters to the selected VAV controller via the gateway. The selected VAV controller stores the one or more changed VAV parameters in a memory of the selected VAV controller and then controls the selected VAV controller using the one or more changed VAV parameters.

In some cases, a test and balance procedure may be initiated on the selected VAV controller via the user interface of the portable handheld device. In response, a test and balance procedure may be performed on the selected VAV controller. In some cases, initiating a test and balance procedure may include receiving a selection of a method of calibration from a plurality of methods of calibration via the user interface of the portable handheld device. In some cases, initiating a test and balance procedure may include receiving a selection of an airflow setpoint at which calibration is to be performed via the user interface of the portable handheld device. In some cases, a determination may be made that the airflow setpoint has been met. The portable handheld device may display a notification on the display of the portable handheld device that the airflow setpoint has been met. Once the airflow setpoint has been met, the portable handheld device may solicit and receive a measured airflow via the user interface of the portable handheld device.

In some cases, the selected VAV controller may override commands from the BMS controller during the test and balance procedure. The portable handheld device may send commands to the selected VAV controller to stop overriding commands from the BMS controller, and in response, the selected VAV controller may stop overriding commands from the BMS controller. In some cases, the selected VAV controller may detect an unexpected disconnection from the portable handheld device, and in response, the selected VAV controller may automatically stop overriding commands from the BMS controller.

In some cases, in addition to providing the test and balance procedure, the portable handheld device may allow a user to initiate a zero calibration procedure of the selected VAV controller. In some cases, in addition to providing the test and balance procedure, the portable handheld device may allow a user to initiate a move damper procedure of the selected VAV controller, wherein the move damper procedure allows a user to set and lock a damper position of a damper of the selected VAV controller at a desired damper position. In some cases, the move damper procedure may allow the user to set and lock the damper position at a selected percent open position. In some cases, the move damper procedure may allow the user to set and lock the damper at a damper position that produces a selected airflow.

A portable handheld device may be used to commission and/or maintain one or more of a plurality of Variable Air Volume (VAV) controllers that are each associated with a corresponding VAV box, wherein the plurality of VAV controllers are operably connected together and operatively coupled to a Building Management System (BMS) controller via a building control network. The portable handheld device includes a user interface with display. The portable handheld device establishes a wireless connection with a gateway that provides access to the building control network. The portable handheld device receives via the gateway information about each of one or more of the plurality of VAV controllers that are operably connected to the building control network. The information identifies an application type of a plurality of application types for each of the one or more of the plurality of VAV controllers, wherein each application type has associated VAV parameters that are used in controlling the respective VAV controller, wherein the plurality of application types includes two or more of single duct, dual duct, cooling only, cooling with reheat, fan parallel, fan series, reheat, and heating. Based on the application type received for each of the one or more of the plurality of VAV controllers, the portable handheld device may adapt the display for each of the one or more of the plurality of VAV controllers to display the VAV parameters that are associated with the application type of the respective VAV controller.

In some cases, a selection of a selected one of the one or more of the plurality of VAV controllers may be received via the user interface of the portable handheld device. A change to one or more of the VAV parameters that are associated with the application type of the selected VAV controller may be received, resulting in one or more changed VAV parameters.

The portable handheld device sends the one or more changed VAV parameters to the selected VAV controller via the gateway and the selected VAV controller controls the selected VAV controller using the one or more changed VAV parameters. In some cases, a selection of one or more of the plurality of VAV controllers may be received via the user interface of the portable handheld device. A test and balance procedure on each of the selected one or more of the plurality of VAV controllers may be initiated via the user interface of the portable handheld device. In response, the test and balance procedure may be performed on the selected one or more of the plurality of VAV controllers. In some cases, each of the selected one or more of the plurality of VAV controllers may override commands from the BMS controller during the test and balance procedure. The portable handheld device may send commands to the selected one or more of the plurality of VAV controllers to stop overriding commands from the BMS controller, and in response, the selected one or more of the plurality of VAV controllers stop overriding commands from the BMS controller.

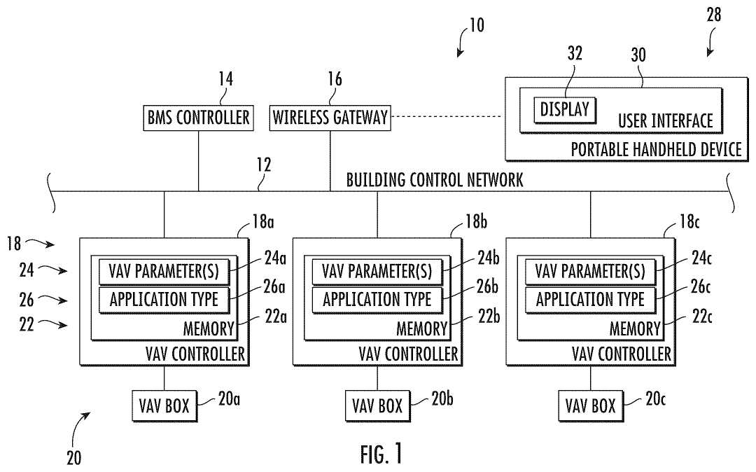

FIG. 1 is a schematic block diagram showing an illustrative building system 10.

The illustrative building system 10 includes a building control network 12 that may represent a wired or wireless network within a building. A Building Management System (BMS) controller 14 is operably coupled to the building control network 12. A wireless gateway 16 is operably coupled to the building control network 12, and is configured to provide access to the building control network 12. The building system 10 includes a number of VAV controllers 18, individually labeled as 18a, 18b, and 18c. While a total of three VAV controllers 18 are shown, this is merely illustrative, as the building system 10 may include any number of VAV controllers 18 and in some cases may include considerably more than three VAV controllers 18. Each of the VAV controller 18 are associated with, and control operation of, a corresponding VAV box 20, individually labeled as 20a, 20b, and 20c. In some cases, there is one VAV controller 18 associated with each of the VAV boxes 20. In some cases, a VAV controller 18 may be associated with, and control operation of, two or more different VAV boxes 20. In some cases, the plurality of VAV controllers 18 may be are operably connected together and operatively coupled to the BMS controller 14 via the building control network 12.

Each of the VAV controllers 18 include a memory 22, individually labeled as 22a, 22b, and 22c. Each of the memories 22 store one or more VAV parameter(s) 24, individually labeled as 24a, 24b, and 24c. Each of the memories 22 store an application type 26, individually labeled as 26a, 26b, and 26c.

A portable handheld device 28 may be a tablet, a phablet or a smartphone, for example. The portable handheld device 28 includes a user interface 30 that has a display 32. In some cases, the portable handheld device 28 may include a touchscreen that provides both the user interface 30 and the display 30. The portable handheld device 28 is configured to establish a wireless connection with the wireless gateway 16 and to receive via the wireless gateway 16 information about each of one or more of the plurality of VAV controllers 18. The information identifies an application type 26 from a plurality of application types for each of the one or more of the plurality of VAV controllers 18. Each application type 26 has associated VAV parameters 24 that are used in controlling the respective VAV controller 18 and associated VAV box 20.

The portable handheld device 28 is configured to adapt the display 32 for each of the one or more of the plurality of VAV controllers 18 to display the VAV parameters 24 that are associated with the application type 26 of the respective VAV controller 18. The portable handheld device 28 is configured to receive a selection of one of the one or more of the VAV controllers 18 via the user interface 32 and to receive a change to one or more of the VAV parameters 24 that are associated with the application type 26 of the selected VAV controller 18 via the user interface 30, resulting in one or more changed VAV parameters. The portable handheld device 28 is configured to send the one or more changed VAV parameters to the selected VAV controller 18 via the wireless gateway 16 and to initiate a test and balance procedure on the selected VAV controller and associated VAV box 20 via the user interface 30.

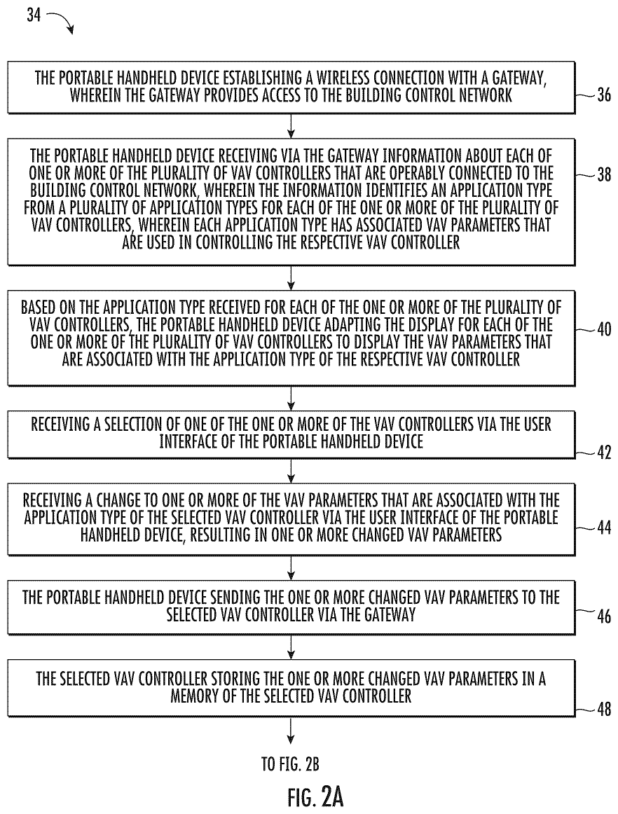

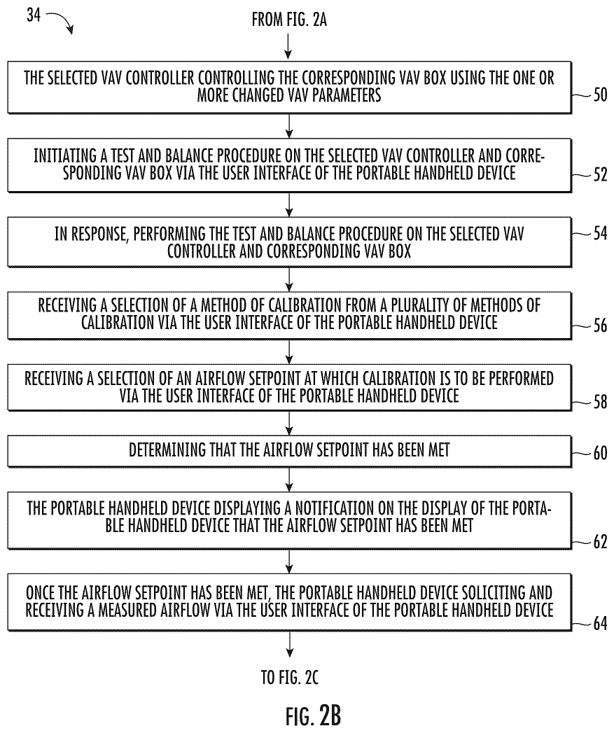

FIGS. 2A, 2B, and 2C are flow diagrams that together show an illustrative method 34 of using a portable handheld device (such as the portable handheld device 28) to commission and/or maintain one or more of a plurality of VAV controllers (such as the VAV controllers 18) that are each associated with a corresponding VAV box (such as the VAV boxes 20). The plurality of VAV controllers are operably connected together and operatively coupled to a BMS controller (such as the BMS controller 14) via a building control network (such as the building control network 12). The portable handheld device includes a user interface (such as the user interface 20) with display (such as the display 32). The method 34 includes the portable handheld device establishing a wireless connection with a gateway (such as the wireless gateway 16) that provides access to the building control network, as indicated at block 36. The portable handheld device receives via the gateway information about each of one or more of the plurality of VAV controllers that are operably connected to the building control network, wherein the information identifies an application type from a plurality of application types for each of the one or more of the plurality of VAV controllers, wherein each application type has associated VAV parameters that are used in controlling the respective VAV controller, as indicated at block 38.

Based on the application type received for each of the one or more of the plurality of VAV controllers, the portable handheld device adapts the display for each of the one or more of the plurality of VAV controllers to display the VAV parameters that are associated with the application type of the respective VAV controller, as indicated at block 40. A selection of one of the one or more of the VAV controllers is received via the user interface of the portable handheld device, as indicated at block 42. A change to one or more of the VAV parameters that are associated with the application type of the selected VAV controller is received via the user interface of the portable handheld device, resulting in one or more changed VAV parameters, as indicated at block 44. The portable handheld device sends the one or more changed VAV parameters to the selected VAV controller via the gateway, as indicated at block 46. The selected VAV controller stores the one or more changed VAV parameters in a memory of the selected VAV controller, as indicated at block 48. Continuing on FIG. 2B, the selected VAV controller controls the corresponding VAV box using the one or more changed VAV parameters, as indicated at block 50.

In some cases, the method 34 may include initiating a test and balance procedure on the selected VAV controller and corresponding VAV box via the user interface of the portable handheld device, as indicated at block 52. In response, the test and balance procedure is performed on the selected VAV controller and corresponding VAV box, as indicated at block 54. In some cases, initiating the test and balance procedure may include receiving a selection of a method of calibration from a plurality of methods of calibration via the user interface of the portable handheld device, as indicated at block 56. In some cases, initiating the test and balance procedure may include receiving a selection of an airflow setpoint at which calibration is to be performed via the user interface of the portable handheld device, as indicated at block 58. In some cases, the method 34 may include determining that the airflow setpoint has been met, as indicated at block 60. In some cases, the portable handheld device may display a notification on the display of the portable handheld device that the airflow setpoint has been met, as indicated at block 62. In some cases, once the airflow setpoint has been met, the portable handheld device may solicit and receive a measured airflow via the user interface of the portable handheld device, as indicated at block 64.

Continuing on FIG. 2C, the method 34 may further include the selected VAV controller overriding commands from the BMS controller during the test and balance procedure, as indicated at block 66. In some cases, the portable handheld device may send commands to the selected VAV controller to stop overriding commands from the BMS controller, and in response, the selected VAV controller may stop overriding commands from the BMS controller, as indicated at block 68. In some cases, the selected VAV controller may detect an unexpected disconnection from the portable handheld device, and in response, the selected VAV controller may automatically stop overriding commands from the BMS controller, as indicated at block 70.

In some cases, the method 34 may further include, in addition to providing the test and balance procedure, the portable handheld device allowing a user to initiate a zero calibration procedure of the selected VAV controller, as indicated at block 72. In some cases, the method 34 may further include, in addition to providing the test and balance procedure, the portable handheld device allowing a user to initiate a move damper procedure of the selected VAV controller and corresponding VAV box, wherein the move damper procedure allows a user to set and lock a damper position of a damper of the corresponding VAV box at a desired damper position, as indicated at block 74. In some cases, the move damper procedure may allow the user to set and lock the damper position at a selected percent open position. In some cases, the move damper procedure may allow the user to set and lock the damper at a damper position that produces a selected airflow. In some cases, the plurality of application types may include two or more of single duct, dual duct, cooling only, cooling with reheat, fan parallel, fan series, reheat, and heating. In some cases, for application types of fan parallel and/or fan series, the portable handheld device may display on option on the display to command a fan of the corresponding VAV box to be ON or OFF and/or to adjust a fan speed of the fan, as indicated at block 76.

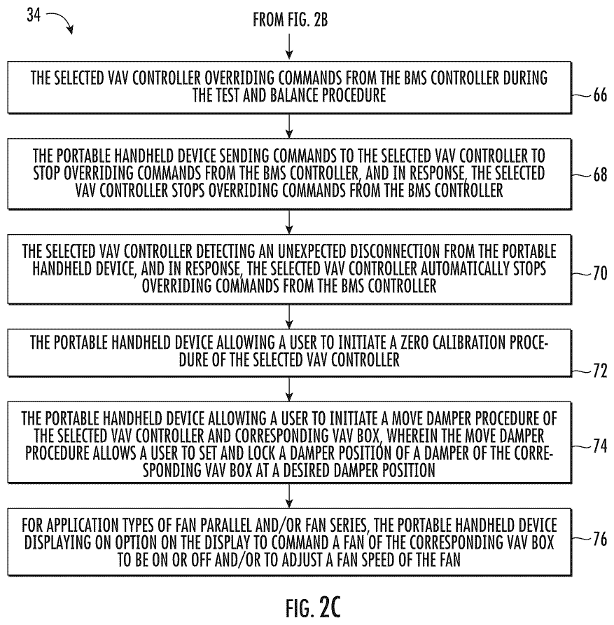

FIGS. 3A and 3B are flow diagrams that together show an illustrative method 78 of using a portable handheld device (such as the portable handheld device 28) to commission and/or maintain one or more of a plurality of VAV controllers (such as the VAV controllers 18) that are each associated with a corresponding VAV box (such as the VAV boxes 20). The plurality of VAV controllers are operably connected together and operatively coupled to a BMS controller (such as the BMS controller 14) via a building control network (such as the building control network 12). The portable handheld device includes a user interface (such as the user interface 20) with display (such as the display 32). The method 78 includes the portable handheld device establishing a wireless connection with a gateway, wherein the gateway provides access to the building control network, as indicated at block 80. The portable handheld device receives via the gateway information about each of one or more of the plurality of VAV controllers that are operably connected to the building control network, wherein the information identifies an application type of a plurality of application types for each of the one or more of the plurality of VAV controllers, wherein each application type has associated VAV parameters that are used in controlling the respective VAV controller, wherein the plurality of application types includes two or more of single duct, dual duct, cooling only, cooling with reheat, fan parallel, fan series, reheat, and heating, as indicated at block 82. Based on the application type received for each of the one or more of the plurality of VAV controllers, the portable handheld device adapting the display for each of the one or more of the plurality of VAV controllers to display the VAV parameters that are associated with the application type of the respective VAV controller, as indicated at block 84.

In some cases, the method 78 may include receiving a selection of a selected one of the one or more of the plurality of VAV controllers via the user interface of the portable handheld device, as indicated at block 86. A change to one or more of the VAV parameters that are associated with the application type of the selected VAV controller may be received, resulting in one or more changed VAV parameters, as indicated at block 88. The portable handheld device may send the one or more changed VAV parameters to the selected VAV controller via the gateway, as indicated at block 90. Continuing on FIG. 3B, the method 78 may include the selected VAV controller controlling the corresponding VAV box using the one or more changed VAV parameters, as indicated at block 92.

In some cases, the method 78 may include receiving a selection of one or more of the plurality of VAV controllers via the user interface of the portable handheld device, as indicated at block 94. A test and balance procedure may be initiated on each of the selected one or more of the plurality of VAV controllers and corresponding VAV boxes via the user interface of the portable handheld device, as indicated at block 96. In response, the test and balance procedure may be formed on the selected one or more of the plurality of VAV controllers and corresponding VAV boxes, as indicated at block 98. In some cases, the method 78 may further include each of the selected one or more of the plurality of VAV controllers overriding commands from the BMS controller during the test and balance procedure, as indicated at block 100. The portable handheld device may send commands to the selected one or more of the plurality of VAV controllers to stop overriding commands from the BMS controller, and in response, the selected one or more of the plurality of VAV controllers stop overriding commands from the BMS controller, as indicated at block 102.

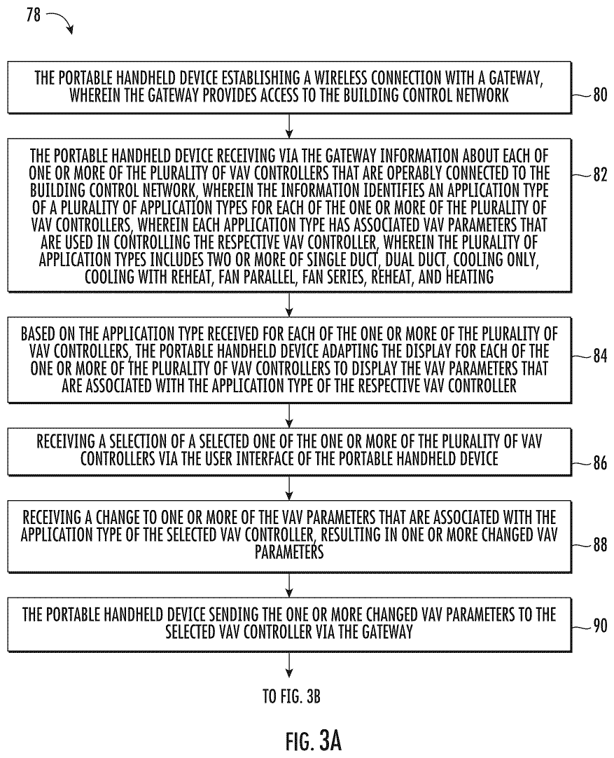

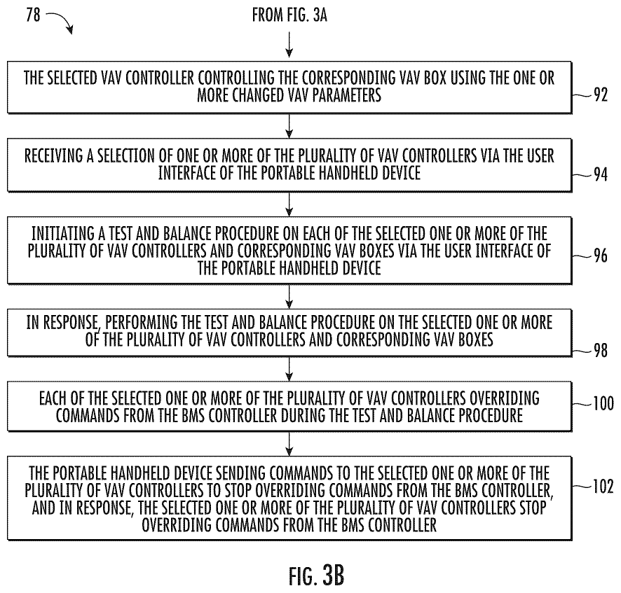

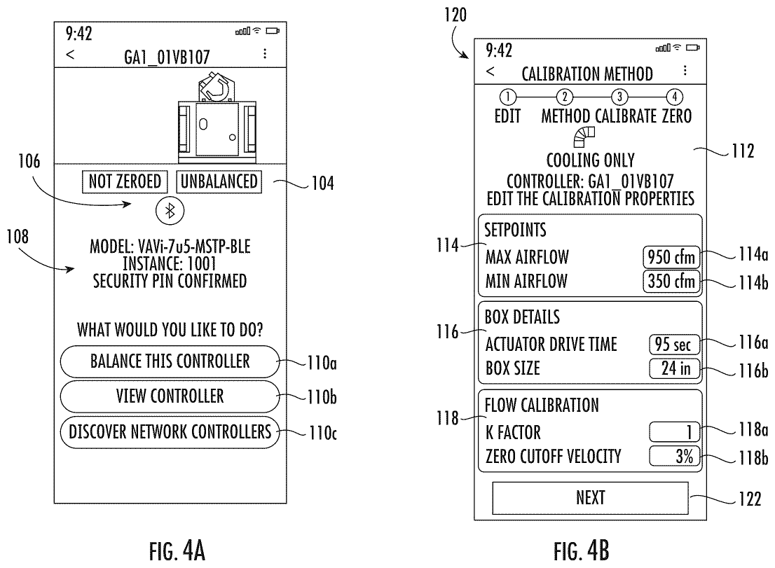

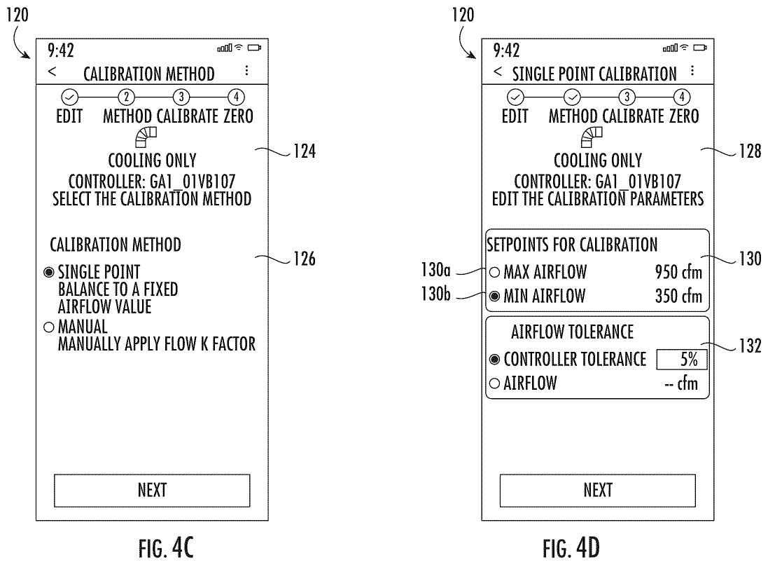

FIGS. 4A, 4B, 4C, and 4D are screenshots from the portable handheld device 28, demonstrating single duct calibration. FIG. 4A shows a screen 104 that includes info buttons 106 indicating that the selected controller, identified at 108, has not yet been zeroed or balanced. The screen 104 includes buttons 110a, 110b, and 110c, soliciting the user to inform the portable handheld device 28 whether they desire to balance the controller (button 110a), view the controller (button 110b), or discover networked controllers (110c). Selecting the button 110a will cause the portable handheld device 28to display a screen 112 as shown in FIG. 4B.

The screen 112 includes a setpoints section 114, a box details section 116, and a flow calibration section 118 that allow the user to input information. The setpoints section 114 includes a box 114a pertaining to a maximum airflow and a box 114b pertaining to a minimum airflow. The boxes 114a and 114b may display the maximum and minimum airflows, respectively, and may allow the user to change one or more of these values if desired. The box details section 116 includes a box 116a pertaining to actuator drive time and a box 116b pertaining to box size (of the VAV box 20). The boxes 116a and 116b may display these parameters, and may allow the user to change one or more of these values if desired. The flow calibration section 118 includes a box 118a pertaining to a K factor and a box 118b pertaining to a zero cutoff velocity. The boxes 118a and 118b may display these parameters, and may allow the user to change one or more of these values if desired.

The screen 112 includes a status bar 120 that informs the user what stage they are at in the calibration process, including an edit stage, a method stage, a calibrate stage, and a zero stage. In FIG. 4B, the status bar 120 indicates that the user is in the process of editing values. The user pressing a NEXT button 122 may cause the portable handheld device 28 to display a screen 124, as shown in FIG. 4C.

As seen in FIG. 4C, the status bar 120 indicates that the editing stage is complete, and that the user in now in the process of selecting a calibration method. The screen 124 includes a section 126 that allows the user to select between a single point calibration in which the VAV box 20 will be balanced to a fixed airflow value, and a manual method in which the user will manually apply a flow K value. As shown, a single point calibration has been selected. Selecting the NEXT button 122 may cause the portable handheld device 28 to display a screen 128, as shown in FIG. 4D.

As seen in FIG. 4D, the status bar 120 now indicates that calibration is underway. The screen 128 includes a setpoints for calibration section 130 and an airflow tolerance section 132. The calibration section 130 allows the user to select between using a max airflow for calibration, as indicated by a radio button 130a, and a min airflow for calibration, as indicated by a radio button 130b. As shown, the min airflow of 350 cfm (cubic feed per minute) has been selected. The calibration section 130 also displays the values for the max airflow and the min airflow for calibration. The airflow tolerance section 132 allows the user to select between using a controller tolerance value, as indicated by a radio button 132a, or an airflow value, as indicated by a radio button 132b. As shown, the controller tolerance value of 5 percent has been selected. Selecting the NEXT button 122 may cause the portable handheld device 28 to move to an additional step, or to return to a previous menu, for example.

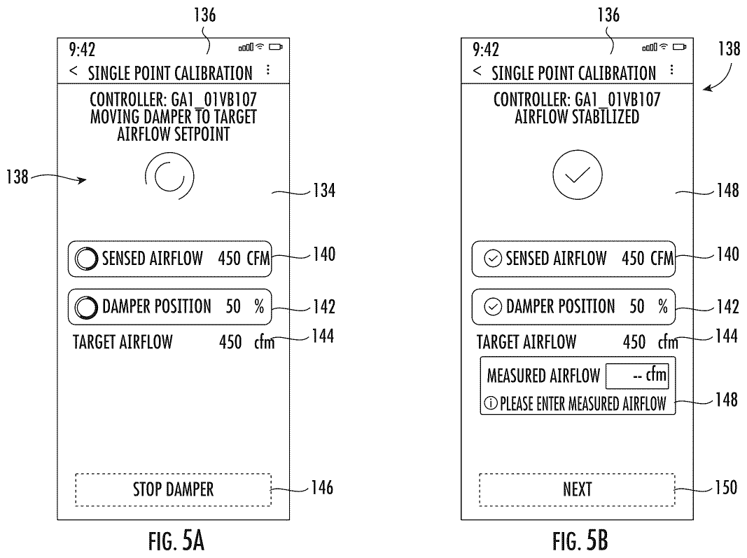

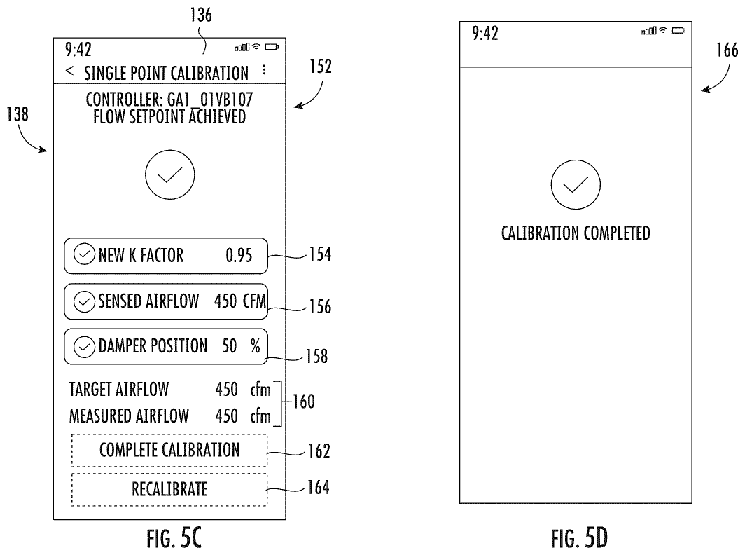

FIGS. 5A, 5B, 5C, and 5D are screenshots from the portable handheld device 28, demonstrating single point balancing. In FIG. 5A, a screen 134 is shown. The screen 134 includes a title bar 136 indicating that single point calibration is underway. The screen 134 includes a section 138 that identifies the specific controller that is being calibrated, as well as a current status of “moving damper to target airflow setpoint”. A section 140 shows that the sensed airflow is underway to achieving a 450 cfm airflow. A section 142 shows that the damper is in the process of achieving a 50 percent damper position. A section 144 shows that the target airflow is 450 cfm. A STOP DAMPER button 146, if selected, may cause the portable handheld device 28 to instruct the associated VAV box 20 to stop moving.

FIG. 5B shows a screen 148 in which the section 138 indicates that the airflow is stabilized. The portable handheld device 28 also displays this information in section 140 and in section 142, by replacing the spinning dial in FIG. 5A with a checkmark in FIG. 5B. A section 148 is displayed by the portable handheld device 28 to allow the user to manually enter a measured airflow value that the user may obtain from an air flow sensor. A NEXT button 150 allows a user to instruct the portable handheld device 28 to move to a subsequent screen, or even to revert to a menu option.

FIG. 5C shows a screen 152 in which the section 138 indicates that the flow setpoint has been achieved. The screen 152 includes a section 154 in which the portable handheld device 28 displays a new K factor. The screen 152 includes a section 156 in which the portable handheld device 28 displays the sensed airflow. The screen 152 includes a section 158 in which the portable handheld device 28 displays the damper position. The screen 152 includes a section 160 in which the portable handheld device 28 displays the target airflow and the measured airflow. The portable handheld device 28 also displays a button 162 that the user may select to indicate they are done with calibration and a button 164 that the user may select to indicate that they wish to repeat the calibration process. FIG. 5D shows a screen 166 that the portable handheld device 28 may display after the user selects the button 162. The screen 166 indicates that calibration has been completed.

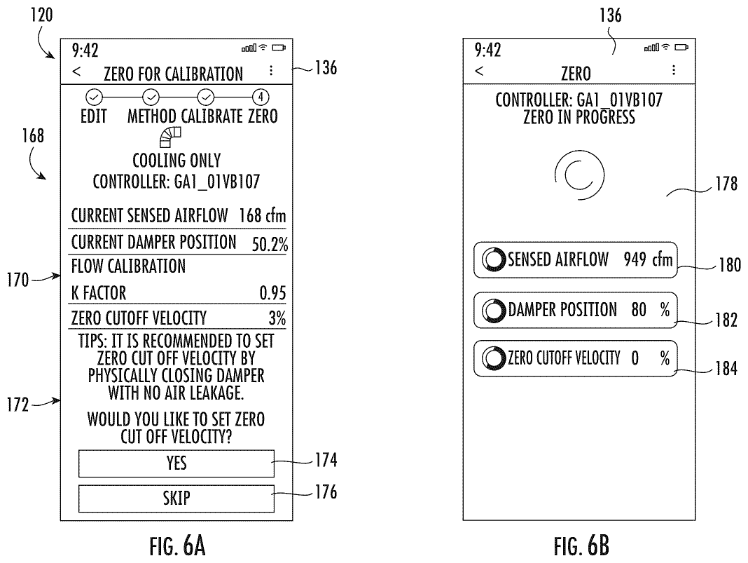

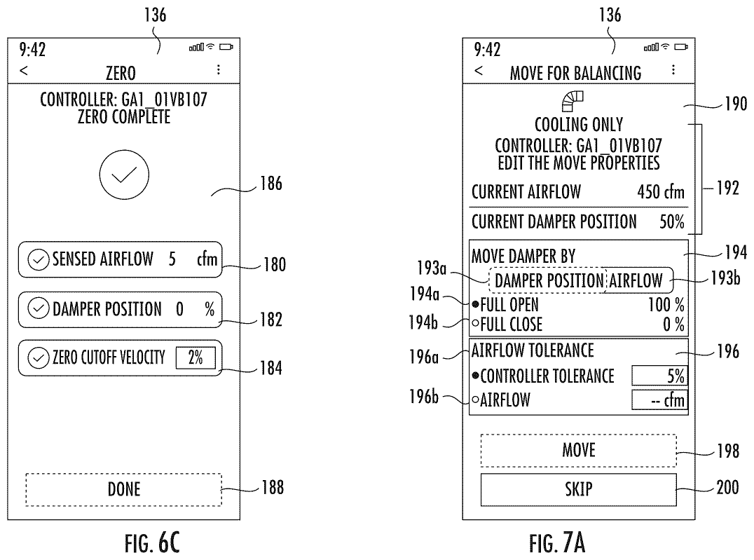

FIGS. 6A, 6B, and 6C are screenshots from the portable handheld device 28, demonstrating zero calibration and damper moving. FIG. 6A shows a screen 168 in which the status bar 120 indicates that it is time to set the zero cutoff velocity value. The portable handheld device 28 displays indicia on the screen 168 that indicates the specific controller, current sensed airflow and damper position. The screen 168 includes a section 170 for flow calibration, including the K factor value and the zero cutoff velocity value. The portable handheld device 28 displays a tips section 172 that informs the user how best to set the zero cutoff velocity value.

The portable handheld device 28 displays a YES button 174 that allows the user to indicate that they want to proceed with setting the zero cutoff velocity value and a SKIP button 176 that allows the user to avoid setting the zero cutoff velocity value at this time.

Pressing the YES button 174 causes the portable handheld device 28 to display a screen 178, as seen in FIG. 6B. The portable handheld device 28 displays an indication of which controller is being calibrated, and that zero is in process. The screen 178 includes a section 180 which displays, in progress, a sensed airflow. The screen 178 includes a section 182 which displays, in progress, a damper position. The screen 178 includes a section 184 which displays, in progress, a zero cutoff velocity value. Once complete, the portable handheld device 28 displays a screen 186, as shown in FIG. 6C. The screen 186 indicates that the zero is completed. The portable handheld device 28 displays on the screen 186 the section 180 indicating the sensed airflow, the screen 182 indicating the damper position, and the screen 184 showing the determined zero cutoff velocity value.

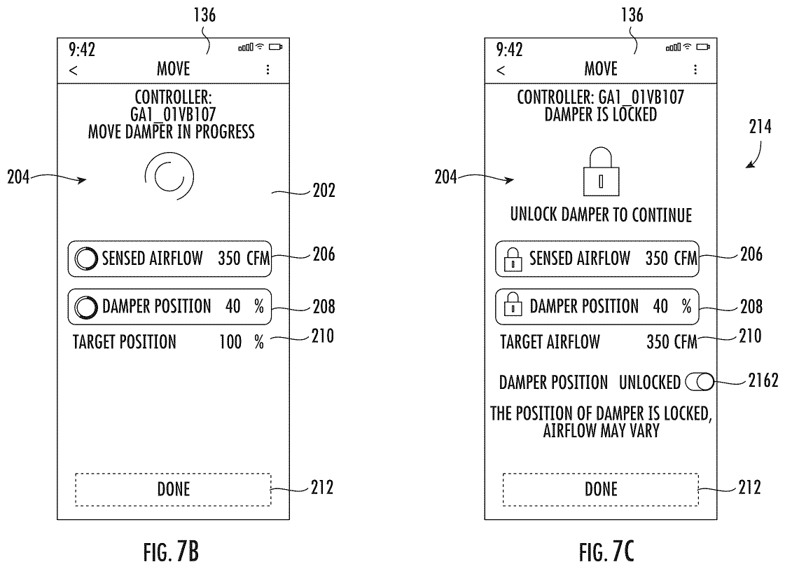

FIGS. 7A, 7B, 7C, and 7D are screenshots from the portable handheld device 28, demonstrating editing move properties. FIG. 7A shows a screen 190 that includes a section 192 providing identifying information identifying the specific controller, the current airflow and the current damper position. The toolbar 136 indicates that it is time for move to balance. The portable handheld device 28 displays a move damper section 194 and an Airflow Tolerance section 196. The move damper section 194 includes a toolbar including a button 193a that selects moving the damper by damper position and a button 193b that selects moving the damper by airflow. The button 193a has been selected. The move damper section 194 includes a radio button 194a allowing a user to select a damper position of full open and a radio button 194b allowing a user to select a damper position of full closed. As shown, the user has selected full open. The airflow tolerance section 196 includes a radio button 196a that allows selection of a controller tolerance value and a radio button 196b that allows selection of an airflow value. The radio button 196a has been selected. A MOVE button 198 may be selected to instruct the portable handheld device 28 to move the damper. A SKIP button 200 may be selected to skip moving the damper.

Pressing the MOVE button 198 may cause the portable handheld device 28 to display a screen 202, as shown in FIG. 7B. The screen 202 includes indicia 204 indicating which controller is being calibrated, and that moving the damper is in progress. A section 206 displays, in progress, a sensed airflow. A section 208 displays, in progress, a damper position. A section 210 displays a target damper position. The screen 202 includes a grayed out DONE button 212.

In some cases, the damper position may become locked. FIG. 7C shows a screen 214 that may be displayed by the portable handheld device 28 when the damper is locked. The indicia 204 indicates that the damper is locked. The portable handheld device 28 displays a damper position lock/unlock slide 216 that may be selected to manually unlock the damper position. FIG. 7D shows a screen 218 that may be displayed once airflow has stabilized, as indicated by the indicia 204 including text stating that airflow is stabilized.

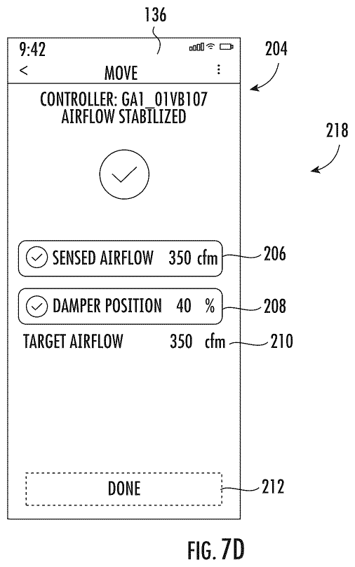

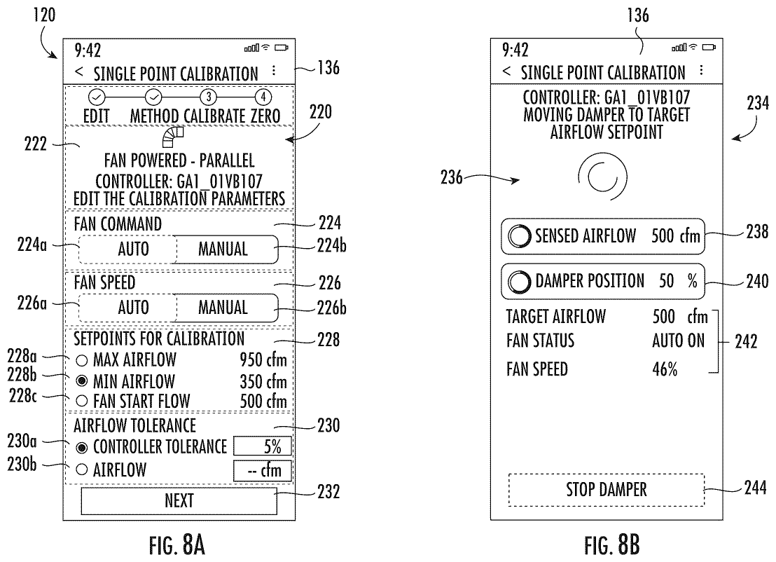

FIGS. 8A and 8B are screenshots from the portable handheld device 28, demonstrating fan applications. In FIG. 8A, the portable handheld device 28 is displaying a screen 220 including the status bar 120 indicating calibrate, and the tool bar 136 indicates single point calibration. A section 222 indicates the specific controller, and that it is time to edit the calibration parameters. A fan command section 224 includes an AUTO button 224a and a MANUAL button 224b. The AUTO button 224a has been selected. A fan speed section 226 includes an AUTO button 226a and a MANUAL button 226b. The AUTO button 226a has been selected. The screen 220 includes a setpoints section 228 including a max airflow radio button 228a, a min airflow radio button 228b, and a fan start flow radio button 228c. The min airflow radio button 228b has been selected. The screen 220 includes an airflow tolerance section 230 including a controller tolerance radio button 230a and an airflow radio button 230b. The controller tolerance radio button 230a has been selected. The portable handheld device 28 displays a NEXT button 232.

In response to a user selecting the NEXT button 232, the portable handheld device 28 may display a screen 234, as shown in FIG. 8B. The screen 234 includes indicia 236 indicating the specific controller and that the damper is being moved to a target airflow setpoint. A section 238 provides, in progress, a sensed airflow. A section 240 provides, in progress, a damper position. A section 242 provides the target airflow, the fan status, and the fan speed.

The portable handheld device 28 displays a STOP DAMPER button 244 that may be selected to stop the damper from moving any further.

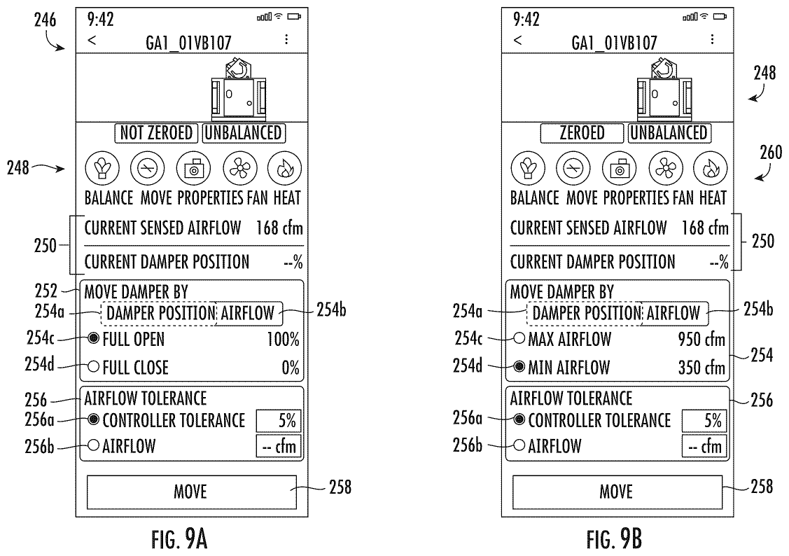

FIGS. 9A and 9B are screenshots from the portable handheld device 28, demonstrating independent balancing options. FIG. 9A shows a screen 246 that includes a status bar 248, providing options including Balance, Move, Properties, Fan, and Heat. Move has been selected. The portable handheld device 28 displays a section 250 that includes the current sensed airflow and the current damper position. A move damper section 252 includes a DAMPER POSITION button 254a that allows the user to select moving the damper to a particular location and an AIRFLOW button 254b that allows the user to select moving the damper in accordance with a desired airflow rate. The DAMPER POSITION button 254a has been selected. The portable handheld device 28 displays a full open radio button 254c and a full close radio button 254d. The full open radio button 254c has been selected. An airflow tolerance section 256 includes a controller tolerance radio button 256a and an airflow radio button 256b. The controller tolerance radio button 256a has been selected. A MOVE button 258, if selected, causes the damper to move accordingly.

FIG. 9B shows a screen 260 that is similar to the screen 246 shown in FIG. 9A, although in FIG. 9B the AIRFLOW button 254b has been selected instead of the DAMPER POSITION button 254a. The move damper section 254 also shows that the min airflow radio button 254d has been selected. Otherwise, the screen 260 is similar to the screen 246.

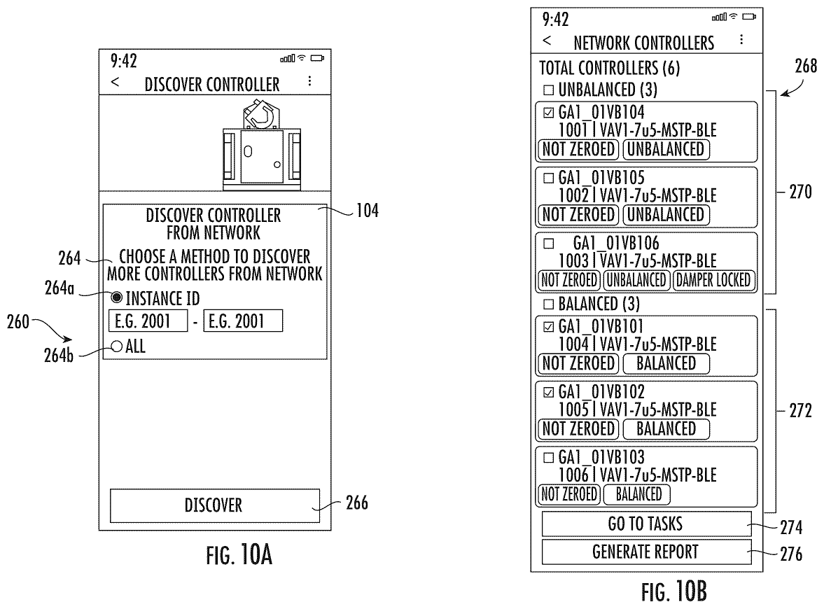

FIGS. 10A and 10B are screenshots from the portable handheld device 28, demonstrating discovering multiple controllers. FIG. 10A shows a screen 262 that may be generated by the portable handheld device 28. The screen 262 includes a section 264 that allows a user to select how they wish to discover more controllers, including a radio button 264a for using an Instance ID and a radio button 264b for all controllers. The radio button 264a is selected. A DISCOVER button 266, when selected, instructs the portable handheld device 28 to look for controllers with the specified criteria.

Selecting the DISCOVER button 266 may cause the portable handheld device 28 to display a screen 268, as shown in FIG. 10B. The screen 268 includes a list of selectable controllers, including a list 270 of unbalanced controllers and a list 272 of balanced controllers. As shown, a user has selected certain controllers to be calibrated. The screen 268 includes a GO TO TASKS button 274 that may be used to proceed to carrying out one or more tasks, including one or more of balancing, zero calibration, move, unlock damper, resume to normal, clear zero and balance, and others. The screen 268 includes a GENERATE REPORT button 276 that may be selected to instruct the portable handheld device 28 to generate any of a variety of different reports.

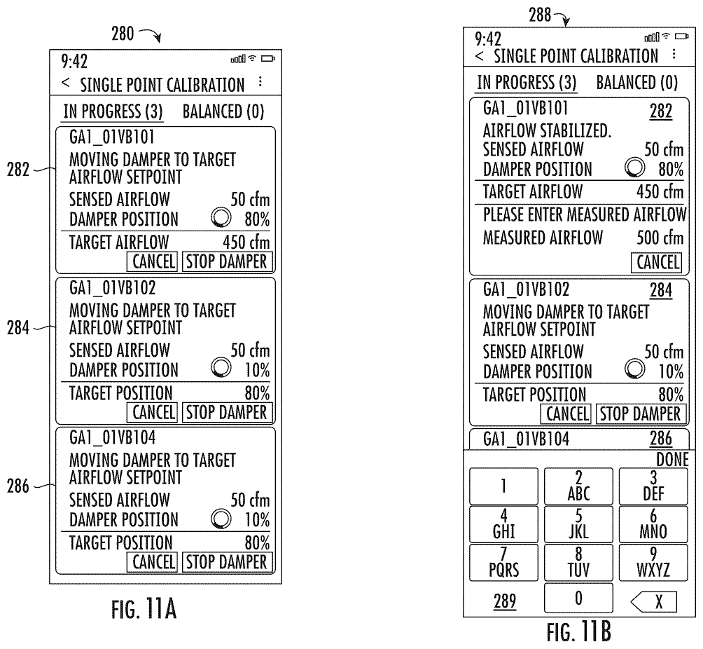

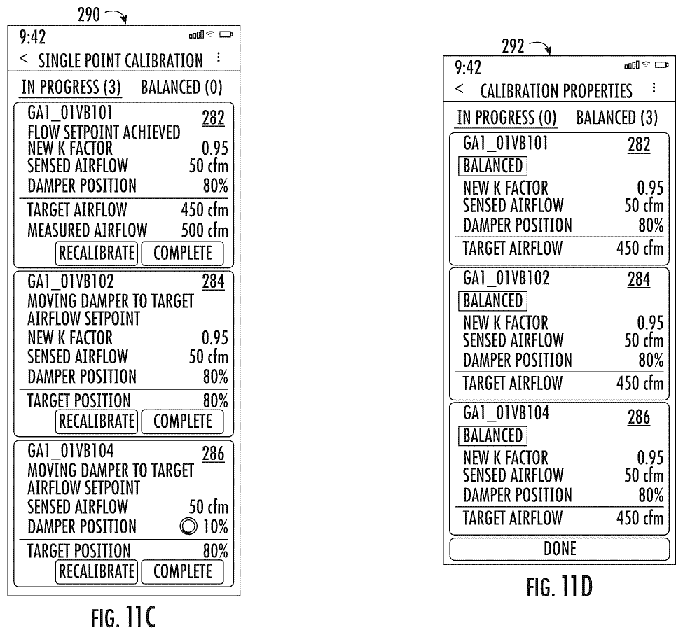

FIGS. 11A, 11B, 11C, and 11D are screenshots from the portable handheld device 28, demonstrating balancing multiple controllers. FIG. 11A shows a screen 280 that shows several controllers that are currently moving a damper to a target airflow setting. The screen 280 includes a section 282 for a first controller, a section 284 for a second controller, and a section 286 for a third controller. FIG. 11B shows a screen 288 that shows an updated status. Section 282 shows that the first controller has stabilized airflow while section 284 shows that the second controller is still moving the damper. A keypad has been superimposed over the section 286.

FIG. 11C shows a screen 290 that shows an updated status. Section 282 shows that the first controller has achieved a flow setpoint. Section 284 shows that the second controller is still moving its damper to the target airflow setting. Section 286 shows that the third controller is still moving its damper to the target airflow setting. FIG. 11D shows a screen 292 that shows an updated status. As shown, all three of the controllers are now balanced, and updated parameters are displayed.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method of using a portable handheld device to commission and/or maintain one or more of a plurality of Variable Air Volume (VAV) controllers that are each associated with a corresponding VAV box, wherein the plurality of VAV controllers are operably connected together and operatively coupled to a Building Management System (BMS) controller via a building control network, wherein the portable handheld device includes a user interface with display, the method comprising:
the portable handheld device establishing a wireless connection with a gateway, wherein the gateway provides access to the building control network;
the portable handheld device receiving via the gateway information about each of one or more of the plurality of VAV controllers that are operably connected to the building control network, wherein the information identifies an application type from a plurality of application types for each of the one or more of the plurality of VAV controllers, wherein each application type has associated VAV parameters that are used in controlling the respective VAV controller;
based on the application type received for each of the one or more of the plurality of VAV controllers, the portable handheld device adapting the display for each of the one or more of the plurality of VAV controllers to display the VAV parameters that are associated with the application type of the respective VAV controller;
receiving a selection of one of the one or more of the VAV controllers via the user interface of the portable handheld device;
receiving a change to one or more of the VAV parameters that are associated with the application type of the selected VAV controller via the user interface of the portable handheld device, resulting in one or more changed VAV parameters;
the portable handheld device sending the one or more changed VAV parameters to the selected VAV controller via the gateway;
the selected VAV controller storing the one or more changed VAV parameters in a memory of the selected VAV controller; and
the selected VAV controller controlling the corresponding VAV box using the one or more changed VAV parameters.

2. The method of claim 1, comprising:
initiating a test and balance procedure on the selected VAV controller and corresponding VAV box via the user interface of the portable handheld device; and
in response, performing the test and balance procedure on the selected VAV controller and corresponding VAV box.

3. The method of claim 2, wherein initiating the test and balance procedure comprises receiving a selection of a method of calibration from a plurality of methods of calibration via the user interface of the portable handheld device.

4. The method of claim 2, wherein initiating the test and balance procedure comprises receiving a selection of an airflow setpoint at which calibration is to be performed via the user interface of the portable handheld device.

5. The method of claim 4, comprising:
determining that the airflow setpoint has been met; and
the portable handheld device displaying a notification on the display of the portable handheld device that the airflow setpoint has been met.

6. The method of claim 5, comprising:
once the airflow setpoint has been met, the portable handheld device soliciting and receiving a measured airflow via the user interface of the portable handheld device.

7. The method of claim 2, comprising:
the selected VAV controller overriding commands from the BMS controller during the test and balance procedure.

8. The method of claim 7, comprising:
the portable handheld device sending commands to the selected VAV controller to stop overriding commands from the BMS controller, and in response, the selected VAV controller stops overriding commands from the BMS controller.

9. The method of claim 7, comprising:
the selected VAV controller detecting an unexpected disconnection from the portable handheld device, and in response, the selected VAV controller automatically stops overriding commands from the BMS controller.

10. The method of claim 2, comprising:
in addition to providing the test and balance procedure, the portable handheld device allowing a user to initiate a zero calibration procedure of the selected VAV controller.

11. The method of claim 2, comprising:
in addition to providing the test and balance procedure, the portable handheld device allowing a user to initiate a move damper procedure of the selected VAV controller and corresponding VAV box, wherein the move damper procedure allows a user to set and lock a damper position of a damper of the corresponding VAV box at a desired damper position.

12. The method of claim 11, wherein the move damper procedure allows the user to set and lock the damper position at a selected percent open position.

13. The method of claim 11, wherein the move damper procedure allows the user to set and lock the damper at a damper position that produces a selected airflow.

14. The method of claim 1, wherein the plurality of application types includes two or more of single duct, dual duct, cooling only, cooling with reheat, fan parallel, fan series, reheat, and heating.

15. The method of claim 14, wherein for application types of fan parallel and/or fan series, the portable handheld device displays on option on the display to command a fan of the corresponding VAV box to be ON or OFF and/or to adjust a fan speed of the fan.

16. A method of using a portable handheld device to commission and/or maintain one or more of a plurality of Variable Air Volume (VAV) controllers that are each associated with a corresponding VAV box, wherein the plurality of VAV controllers are operably connected together and operatively coupled to a Building Management System (BMS) controller via a building control network, the portable handheld device includes a user interface with display, the method comprising:
the portable handheld device establishing a wireless connection with a gateway, wherein the gateway provides access to the building control network;
the portable handheld device receiving via the gateway information about each of one or more of the plurality of VAV controllers that are operably connected to the building control network, wherein the information identifies an application type of a plurality of application types for each of the one or more of the plurality of VAV controllers, wherein each application type has associated VAV parameters that are used in controlling the respective VAV controller, wherein the plurality of application types includes two or more of single duct, dual duct, cooling only, cooling with reheat, fan parallel, fan series, reheat, and heating; and
based on the application type received for each of the one or more of the plurality of VAV controllers, the portable handheld device adapting the display for each of the one or more of the plurality of VAV controllers to display the VAV parameters that are associated with the application type of the respective VAV controller.

17. The method of claim 16, comprising:
receiving a selection of a selected one of the one or more of the plurality of VAV controllers via the user interface of the portable handheld device;
receiving a change to one or more of the VAV parameters that are associated with the application type of the selected VAV controller, resulting in one or more changed VAV parameters;
the portable handheld device sending the one or more changed VAV parameters to the selected VAV controller via the gateway; and
the selected VAV controller controlling the corresponding VAV box using the one or more changed VAV parameters.

18. The method of claim 16, comprising:
receiving a selection of one or more of the plurality of VAV controllers via the user interface of the portable handheld device;
initiating a test and balance procedure on each of the selected one or more of the plurality of VAV controllers and corresponding VAV boxes via the user interface of the portable handheld device; and
in response, performing the test and balance procedure on the selected one or more of the plurality of VAV controllers and corresponding VAV boxes.

19. The method of claim 18, comprising:
each of the selected one or more of the plurality of VAV controllers overriding commands from the BMS controller during the test and balance procedure; and
the portable handheld device sending commands to the selected one or more of the plurality of VAV controllers to stop overriding commands from the BMS controller, and in response, the selected one or more of the plurality of VAV controllers stop overriding commands from the BMS controller.

20. A system comprising:
a building control network;
a Building Management System (BMS) controller;
a plurality of Variable Air Volume (VAV) controllers that are each associated with a corresponding VAV box, wherein the plurality of VAV controllers are operably connected together and operatively coupled to the BMS controller via the building control network;
a wireless gateway providing access to the building control network;
a portable handheld device includes a user interface with display, the portable handheld device configured to:
establish a wireless connection with the wireless gateway;
receive via the wireless gateway information about each of one or more of the plurality of VAV controllers, wherein the information identifies an application type from a plurality of application types for each of the one or more of the plurality of VAV controllers, wherein each application type has associated VAV parameters that are used in controlling the respective VAV controller;
adapt the display for each of the one or more of the plurality of VAV controllers to display the VAV parameters that are associated with the application type of the respective VAV controller;
receive a selection of one of the one or more of the VAV controllers via the user interface;
receive a change to one or more of the VAV parameters that are associated with the application type of the selected VAV controller via the user interface, resulting in one or more changed VAV parameters;
send the one or more changed VAV parameters to the selected VAV controller via the wireless gateway; and
initiate a test and balance procedure on the selected VAV controller via the user interface.
